(19) United States
(12) Patent Application Publication
(10) Pub. No.: US 2024/0331338 A1
(43) Pub. Date: Oct. 3, 2024

(54) SYSTEM AND METHOD FOR ACCURATE AND AUTOMATED MULTI-FIELD DATA ANALYSIS

(71) Applicant: University of Central Florida Research Foundation, Inc., Orlando, FL (US)

(72) Inventors: Wasfy B. Mikhael, Orlando, FL (US); Maedeh Sadat Fasihi, Orlando, FL (US)

(21) Appl. No.: 18/623,632

(22) Filed: Apr. 1, 2024

Related U.S. Application Data
(60) Provisional application No. 63/456,222, filed on Mar. 31, 2023.

(51) Int. Cl. G06V 10/25; G06T 7/00; G06T 7/11

(52) U.S. Cl. CPC G06V 10/25; G06T 7/0012; G06T 7/11; G06T 2207/30016

(57) ABSTRACT

Described herein relates to system and method for detecting an abnormal presence within at least one dataset. In an embodiment, the dataset may comprise 1D signals, and/or multidimensional signals (e.g., images). The multi-field data analysis system (hereinafter “system”) may be configured to detect at least one type of abnormality that may not be detected visually otherwise (e.g., analysis by an expert). In addition, the system may be configured to detect the size and/or shape of the abnormality. In this embodiment, the system may also retain the physical location (spatial information) of the abnormality. As such, the system may optimize computation and/or implementation due to the system's ability to project the data on any appropriate domain (e.g., transform domains). Moreover, the system may be configured to search for abnormalities and/or particular characteristics any biometric signal known in the art.

### CROSS-REFERENCE TO RELATED APPLICATIONS

This nonprovisional application claims priority to U.S. Provisional Patent Application No. 63/456,222 entitled “SYSTEM AND METHOD FOR ACCURATE AND AUTOMATED MULTI-FIELD DATA ANALYSIS” filed Mar. 31, 2023 by the same inventors, all of which is incorporated herein by reference, in its entireties, for all purposes.

### BACKGROUND OF THE INVENTION

### 1. Field of the Invention

This invention relates, generally, to data analysis. More specifically, it relates to system and method for detecting an abnormal presence within at least one dataset.

### 2. Brief Description of the Prior Art

Test information is usually only available in the form of 1D or 2D in the biomedical field, for example EKG signals, cat-scans, Magnetic Resonance Image (hereinafter “MRI”). Because of this, all of the data associated with these scans and/or images must be analyzed individually in order to be analyzed to identify if there is any abnormality present. While there is a wide variety of data collection techniques, as well as approaches for obtaining diagnosis from the data such as visual examination by experts, automated machine learning systems, etc., these systems can be extremely time consuming and/or expensive based on the machinery and programming used. Additionally, in some systems, individual user input may be required for each subject under testing, which will increase the time for diagnosis for any abnormality present (e.g., a brain tumor), which may impede the subject from receiving treatment in an appropriate amount of time.

Additionally, the data analysis systems known in the art may require individual expert analysis, which may lead to additional human error in analysis and diagnosis of a potential abnormality. In this manner, as stated above, systems which comprise computational aspects, often require significant processing time, which may lead to delayed treatment of the abnormality.

Accordingly, what is needed is an accurate, efficient, and multi-applicable system and method for detecting at least one abnormal presence within at least one dataset. However, in view of the art considered as a whole at the time the present invention was made, it was not obvious to those of ordinary skill in the field of this invention how the shortcomings of the prior art could be overcome.

### SUMMARY OF THE INVENTION

The long-standing but heretofore unfulfilled need, stated above, is now met by a novel and non-obvious invention disclosed and claimed herein. In an aspect, the present disclosure pertains to a computing device implemented method of automatically detecting at least one anomaly within a subject dataset, in real-time. In an embodiment, the method may comprise the steps of: (a) inputting, via at least one processor of a computing device, the subject dataset and/or a reference dataset, such that an appropriate marker and/or boundary may be defined based on the reference dataset; (b) preprocessing, via the at least one processor of the computing device, the subject data based on the defined marker and/or the defined boundary; and (c) automatically identifying, via a similarity metric of the at least one processor, the at least one anomaly within the subject dataset by: (i) based on a determination that a calculated similarity is greater than or equal to a predetermined similarity threshold, transmitting a notification indicative of the at least one anomaly being present within the subject dataset; and (ii) based on a determination that a calculated similarity is not greater than or equal to a predetermined similarity threshold, transmitting a notification indicative of the at least one anomaly not being present within the subject dataset.

In some embodiments, the at least one dataset may comprise 1D signals and/or multidimensional signals. In these other embodiments, the step of preprocessing the subject data based on the defined marker and/or the defined boundary may further comprise the step of, partitioning the subject dataset based on the defined marker and/or the defined boundary, or both based on the reference dataset. As such, the subject dataset may be partitioned into non-overlapping windows and/or overlapping windows.

In some embodiments, the step of automatically identifying the at least one anomaly within the subject dataset may further comprise the step of, calculating, via at least one correlation method of the at least one processor, a region of interest within the subject dataset based on the defined marker and/or the defined boundary of the reference dataset. In these other embodiments, the step of automatically identifying the at least one anomaly within the subject dataset may also further comprise the step of, highlighting the region of interest, via the at least one processor of the computing device, by: (A) based on a determination that the calculated similarity is greater than or equal to the predetermined similarity threshold, disposing, via a display device communicatively coupled to the at least one processor, a bounding box about the region of interest within the subject dataset; and (B) based on a determination that the calculated similarity is not greater than or equal to the predetermined similarity threshold, maintaining, in real-time, the subject dataset based on the defined marker and/or the defined boundary of the reference dataset.

Additionally, in these other embodiments, the step of automatically identifying the at least one anomaly within the subject dataset may further comprise the step of, segmenting, via at least one segmentation algorithm of the at least one processor, the region of interest of the subject dataset, such that the region of interest may be partitioned, optimizing a feature extraction of the at least one anomaly. In this manner, the method may further comprise the step of, extracting at least one feature, via at least one deep learning algorithm of the at least one processor, from the region of interest. In these other embodiments, the method may also further comprise the step of, determining, via at least one classifier of the at least one processor, the at least one extracted feature of the region of interest.

In some embodiments, the at least one extracted feature may be selected from a group comprising of a tumor, healthy tissue, an aneurysm, a blood clot, gray matter, skull, brain matter, and/or a combination of thereof. In this manner, the at least one processor may also be configured to implement Discrete Cosine Transform, Wavelet domains, and/or spatial domains on the subject dataset and/or the reference dataset.

Moreover, another aspect of the present disclosure pertains to a system for automatically detecting at least one anomaly within a subject dataset, in real-time. In an embodiment, the system may comprise the following: (a) a computing device having at least one processor; and (b) a non-transitory computer-readable medium operably coupled to the processor, the computer-readable medium having computer-readable instructions stored thereon that, when executed by the at least one processor, cause the system to automatically detect at least one anomaly within a subject dataset by executing instructions comprising: (i) inputting, via at least one processor of a computing device, the subject dataset and/or a reference dataset, such that an appropriate marker and/or boundary may be defined based on the reference dataset; (ii) preprocessing, via the at least one processor of the computing device, the subject data based on the defined marker and/or the defined boundary; and (iii) automatically identifying, via a similarity metric of the at least one processor, the at least one anomaly within the subject dataset by: (A) based on a determination that a calculated similarity is greater than or equal to a predetermined similarity threshold, transmitting a notification indicative of the at least one anomaly being present within the subject dataset; and (B) based on a determination that a calculated similarity is not greater than or equal to a predetermined similarity threshold, transmitting a notification indicative of the at least one anomaly not being present within the subject dataset.

In some embodiments, the at least one dataset may comprise 1D signals, and/or multidimensional signals. In these other embodiments, the step of preprocessing the subject data based on the defined marker and/or the defined boundary of the executed instructions may further comprise the step of, partitioning the subject dataset based on the defined marker and/or the defined boundary based on the reference dataset. As such, the subject dataset may be partitioned into non-overlapping windows and/or overlapping windows.

In addition, in some embodiments, the step of automatically identifying the at least one anomaly within the subject dataset of the executed instructions may further comprise the step of, calculating, via at least one correlation method of the at least one processor, a region of interest within the subject dataset based on the defined marker and/or the defined boundary of the reference dataset. In these other embodiments, the step of automatically identifying the at least one anomaly within the subject dataset of the executed instructions may further comprise the step of, highlighting the region of interest, via the at least one processor of the computing device, by: (I) based on a determination that the calculated similarity is greater than or equal to the predetermined similarity threshold, disposing, via a display device communicatively coupled to the at least one processor, a bounding box about the region of interest within the subject dataset; and (II) based on a determination that the calculated similarity is not greater than or equal to the predetermined similarity threshold, maintaining, in real-time, the subject dataset based on the defined marker, the defined boundary, or both of the reference dataset.

In these other embodiments, the step of automatically identifying the at least one anomaly within the subject dataset of the executed instructions may further comprise the step of, segmenting, via at least one segmentation algorithm of the at least one processor, the region of interest of the subject dataset, such that the region of interest may be partitioned, optimizing a feature extraction of the at least one anomaly. In this manner, the executed instructions may further comprise the step of, extracting at least one feature, via at least one deep learning algorithm of the at least one processor, from the region of interest. Furthermore, in these other embodiments, the executed instructions may further comprise the step of, determining, via at least one classifier of the at least one processor, the at least one extracted feature of the region of interest.

In some embodiments, the system may be configured to divided at least one scan into sub-images (e.g., either disjoint or overlapping sub-images) of dimensions n×m. In this manner, in an embodiment, “n” and/or “m” may be determined based on at least one real data set, for example, cat scans. As such, in these other embodiments, each sub-image inputted into the system may then be compared with at least one reference sub-image comprising the at least one abnormal presence (e.g., a tumor sub-image) by using any comparison and/or correlation method known in the art in a spatial domain and/or any alternative domain known in the art. For example, in these other embodiments, at least one similarity metric (e.g., a Structural Similarity Index Metric (hereinafter “SSIM”)) may be used to demonstrate the technique. Accordingly, once there is a similarity close to 1, via the at least one similarity metric, a partial detection of the target (e.g., the tumor) may occur. Therefore, the location of the at least one abnormal presence within the at least one sub-image may be determined. As such, in this embodiment, the target sub-image location may be revisited and/or the size and location of the window may be optimized on a display device in electrical communication with a computing device of the system, where the computing device comprises at least one processor.

As such, in some embodiments, the system may be configured to detecting at least one abnormal presence. In this manner, at least one data set may correlate to a total amount of abnormal presences detected within the at least one real data set. Additionally, in these other embodiments, the system may be configured to detect at least one abnormal presence not capable of being detected visually and/or auditorily.

Additionally, in some embodiments, the system may be configured to determine a size and/or shape of the at least one abnormal presence. In this manner, the size and/or shape may be calculated, via the processor of the computing device, by varying the size of at least one reference and/or at least one target sub-image. As such, the size of the at least one abnormal presence may correspond to the value of the dimensions of the at least one target sub-image, which may correspond to highest correlation.

Moreover, in some embodiments, the system may be configured to record and/or retain a physical location (e.g., spatial information) of the at least one abnormal presence within the at least one inputted sub-image within a memory of the computing device, via the at least one processor. For example, in these other embodiments, the data may be represented in transform domain while retaining the location of the at least one abnormal presence.

Furthermore, in some embodiments, the system may computationally optimize detection of the at least one abnormal presence due to its ability to project the data on any domain known in the art, such that the system may be configured to considerably reduce in a total amount of data required to represent the at least one abnormal presence. In this manner, in these other embodiments, the reduction in the total amount of data required to represent the at least one abnormal presence in turn enhances accuracy, reduces storage requirements and simplifies computation. In addition, the system may be configured to obtain and/or display on the display device of the system at least one result known in the art (e.g., size, location, and/or shape) of the at least one abnormal presence in real-time.

In some embodiments, the system may also be configured to be used in combination of other transform domains known in the art. For example, in these other embodiments, the system may be configured to be integrated into at least one DCT and/or at least one wavelet, in addition to at least one spatial domain regarding the at least one abnormal presence (e.g., a brain tumor). As such, the system may be configured to search for the at least one abnormal presence and/or at least one particular characteristic, via any biometric signal known in the art.

Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings and description are to be regarded as illustrative in nature, and not restrictive.

The invention accordingly comprises the features of construction, combination of elements, and arrangement of parts that will be exemplified in the disclosure set forth hereinafter and the scope of the invention will be indicated in the claims.

### BRIEF DESCRIPTION OF THE DRAWINGS

For a fuller understanding of the invention, reference should be made to the following detailed description, taken in connection with the accompanying drawings, in which:

FIG. 1 is a block diagram of an exemplary process for identifying at least one abnormal presence within at least one subject dataset, according to an embodiment of the present disclosure.

FIG. 2 is a block diagram of reference data selection of the process of FIG. 1, according to an embodiment of the present disclosure.

FIG. 3 is a block diagram of an exemplary process of a subsection selection within the process of FIG. 1, based on a max similarity between inputted subject data and reference data, according to an embodiment of the present disclosure.

FIG. 4 is a block diagram of a classification procedure within the process of FIG. 1, according to an embodiment of the present disclosure.

FIG. 5 is an exemplary image of an inputted dataset, according to an embodiment of the present disclosure.

FIGS. 6A-6B are exemplary inputted subject images with at least one abnormal presence highlighted, according to an embodiment of the present disclosure. FIG. 6A is an exemplary inputted subject image having at least one abnormal presence highlighted.

FIG. 6B is a modified inputted subject image having an abnormal presence mask manually segmented.

FIGS. 7A-7C are exemplary inputted subject images highlighting at least one abnormal presence within at least one dataset, according to an embodiment of the present disclosure. FIG. 7A is an original inputted subject image within the at least one dataset.

FIG. 7B is an inputted subject image highlighting the at least one abnormal presence by manual segmentation. FIG. 7B is an inputted subject image highlighting the at least one abnormal presence by applying a mask on FIG. 7A.

FIGS. 8A-8C are modified exemplary subject images of FIG. 6A, via FIGS. 7A-7C, according to an embodiment of the present disclosure. FIG. 8A is the abnormal presence mask of FIG. 7C inverted. FIG. 8B is a healthy analogous tissue to the abnormal presence region of FIG. 7C by masking FIG. 8A with inputted subject image of FIG. 6. FIG. 8C is a healthy region mimic of the abnormal presence region of FIG. 7A.

FIGS. 9A-9C are further modified exemplary subject images of FIG. 6A, according to an embodiment of the present disclosure. FIG. 9A is the inputted subject image of FIG. 6A with the abnormal presence region removed. FIG. 9B is an inputted subject image of a health analogous tissue in place of the abnormal presence region of FIG. 6A. FIG. 9C is a clean image obtained via the addition of FIG. 9A and FIG. 9B.

FIGS. 10A-10F are exemplary inputted images, in which a set of images has at least one abnormal presence, and an alternative set has no abnormal presence, according to an embodiment of the present disclosure. FIG. 10A is an inputted image with at least one abnormal presence in a spatial domain. FIG. 10B is an inputted image without at least one abnormal presence. FIG. 10C is the inputted image of FIG. 10A after a Discrete Cosine Transform has been applied. FIG. 10D is the inputted image of FIG. 10B after a Discrete Cosine Transform has been applied. FIG. 10E is the inputted image of FIG. 10A in a wavelet domain. FIG. 10F is the inputted image of FIG. 10B in a wavelet domain.

FIG. 11 is an exemplary inputted image, in which at least one abnormal presence region and a normal region corresponding to the at least one abnormal presence region are highlighted, according to an embodiment of the present disclosure.

FIGS. 12A-12F are exemplary inputted images of FIG. 11, in which a set of images comprises the at least one abnormal presence region of FIG. 11, and an alternative set comprises the normal region of FIG. 11 corresponding to the at least one abnormal presence region, according to an embodiment of the present disclosure. FIG. 11A is an inputted image of the abnormal presence region in a spatial domain. FIG. 11B is an inputted image of the health tissue region corresponding to the abnormal presence region. FIG. 11C is the inputted image of FIG. 11A after a Discrete Cosine Transform has been applied. FIG. 11D is the inputted image of FIG. 11B after a Discrete Cosine Transform has been applied. FIG. 11E is the inputted image of FIG. 11A in a wavelet domain. FIG. 11F is the inputted image of FIG. 11B in a wavelet domain.

FIGS. 13A-13H are exemplary inputted images within a spatial domain comprising at least one abnormal presence highlighted, according to an embodiment of the present disclosure. FIG. 13A is an inputted image with a first abnormal presence region highlighted. FIG. 13B is a sectionized image of the inputted image of FIG. 13A with the first abnormal presence region highlighted. FIG. 13C is an inputted image with a second abnormal presence region highlighted. FIG. 13D is a sectionized image of the inputted image of FIG. 13C with the second abnormal presence region highlighted. FIG. 13E is an inputted image with a third abnormal presence region highlighted. FIG. 13F is a sectionized image of the inputted image of FIG. 13E with the third abnormal presence region highlighted. FIG. 13G is an inputted image with a fourth abnormal presence region highlighted. FIG. 13H is a sectionized image of the inputted image of FIG. 13G with the fourth abnormal presence region highlighted.

FIGS. 14A-14H are exemplary inputted images within a DCT domain comprising at least one abnormal presence highlighted, according to an embodiment of the present disclosure. FIG. 14A is an inputted image with a first abnormal presence region highlighted. FIG. 14B is a sectionized image of the inputted image of FIG. 14A with the first abnormal presence region highlighted. FIG. 14C is an inputted image with a second abnormal presence region highlighted. FIG. 14D is a sectionized image of the inputted image of FIG. 14C with the second abnormal presence region highlighted. FIG. 14E is an inputted image with a third abnormal presence region highlighted. FIG. 14F is a sectionized image of the inputted image of FIG. 13E with the third abnormal presence region highlighted. FIG. 14G is an inputted image with a fourth abnormal presence region highlighted. FIG. 14H is a sectionized image of the inputted image of FIG. 14G with the fourth abnormal presence region highlighted.

FIGS. 15A-15B are exemplary inputted imaged within a wavelet domain comprising at least one abnormal presence highlighted, according to an embodiment of the present disclosure. FIG. 15A is an inputted image with a first abnormal presence region highlighted. FIG. 15B is a sectionized image of the inputted image of FIG. 15A with the first abnormal presence region highlighted.

FIG. 16 in a SSIM-map of exemplary inputted image FIG. 6A using overlapping windows with the same size as the at least one abnormal presence template, according to an embodiment of the present disclosure.

FIG. 17 is an exemplary inputted image with at least one abnormal presence highlighted based on max values of an SSIM-map, according to an embodiment of the present disclosure.

FIG. 18 is an exemplary inputted image comprising a selected normal region, according to an embodiment of the present disclosure.

FIG. 19 is a SSIM-map of FIG. 18 using overlapping windows with the same size as the at least one abnormal presence, according to an embodiment of the present disclosure.

FIG. 20 is an exemplary inputted image comprising at least one alternative abnormal presence having a different size, shape, and/or location than the at least one abnormal presence of the exemplary inputted image of FIG. 6A, according to an embodiment of the present disclosure.

FIG. 21 is an SSIM-map using overlapping windows of the exemplary inputted image of FIG. 6A and the at least one alternative abnormal presence of FIG. 20, according to an embodiment of the present disclosure.

FIG. 22 is the exemplary inputted image of FIG. 6A comprising a bounding box surrounding the at least one abnormal presence based on the SSIM-map of FIG. 21, according to an embodiment of the present disclosure.

FIG. 23 is an alternative exemplary inputted image comprising a highlighted region of at least one alternative abnormal presence having a different size, shape, and/or location than the at least one abnormal presence of the exemplary inputted image of FIG. 6A, according to an embodiment of the present disclosure.

FIG. 24 is an SSIM-map using overlapping windows of the exemplary inputted image of FIG. 6A and the at least one alternative abnormal presence of FIG. 23, according to an embodiment of the present disclosure.

FIG. 25 is the exemplary inputted image of FIG. 6A comprising a bounding box surrounding the at least one abnormal presence based on the SSIM-map of FIG. 24, according to an embodiment of the present disclosure.

FIG. 26 is another alternative exemplary inputted image comprising a highlighted region of at least one alternative abnormal presence having a different size, shape, and/or location than the at least one abnormal presence of the exemplary inputted image of FIG. 6A, according to an embodiment of the present disclosure.

FIG. 27 is an SSIM-map using overlapping windows of the exemplary inputted image of FIG. 6A and the at least one alternative abnormal presence of FIG. 26, according to an embodiment of the present disclosure.

FIG. 28 is the exemplary inputted image of FIG. 6A comprising a bounding box surrounding the at least one abnormal presence based on the SSIM-map of FIG. 27, according to an embodiment of the present disclosure.

FIGS. 29A-29D are modified inputted images of the exemplary inputted image of FIG. 6A, according to an embodiment of the present disclosure. FIG. 29A is a modified inputted image in which the inputted image of FIG. 6A is overlayed with the inputted image of FIG. 6A. FIG. 29B is an image highlighting the overlapped region of at least one abnormal presence. FIG. 29C is an SSIM-map using overlapping windows of the exemplary inputted image of FIG. 6A and the exemplary inputted image of FIG. 6A.

FIG. 29D is the exemplary inputted image of FIG. 6A comprising a bounding box surrounding the at least one abnormal presence based on the SSIM-map of FIG. 29C.

FIGS. 30A-30D arc modified inputted images of the exemplary inputted image of FIG. 6A, according to an embodiment of the present disclosure. FIG. 30A is a modified inputted image in which the inputted image of FIG. 6A is overlayed with an alternative image comprising at least one abnormal presence having a different size, shape, and/or location than the at least one abnormal presence of FIG. 6A. FIG. 30B is an image highlighting the overlapped region of at least one abnormal presence. FIG. 30C is an SSIM-map using overlapping windows of the exemplary inputted image of FIG. 6A and the alternative image. FIG. 29D is the exemplary inputted image of FIG. 6A comprising a bounding box surrounding the at least one abnormal presence based on the SSIM-map of FIG. 30C.

### DETAILED DESCRIPTION OF THE INVENTION

In the following detailed description of the preferred embodiments, reference is made to the accompanying drawings, which form a part thereof, and within which are shown by way of illustration specific embodiments by which the invention may be practiced. It is to be understood that one skilled in the art will recognize that other embodiments may be utilized, and it will be apparent to one skilled in the art that structural changes may be made without departing from the scope of the invention.

As such, elements/components shown in diagrams are illustrative of exemplary embodiments of the disclosure and are meant to avoid obscuring the disclosure. Any headings, used herein, are for organizational purposes only and shall not be used to limit the scope of the description or the claims.

Furthermore, the use of certain terms in various places in the specification, described herein, are for illustration and should not be construed as limiting. For example, any reference to an element herein using a designation such as “first,” “second,” and so forth does not limit the quantity or order of those elements, unless such limitation is explicitly stated. Rather, these designations may be used herein as a convenient method of distinguishing between two or more elements or instances of an element. Therefore, a reference to first and/or second elements does not mean that only two elements may be employed there or that the first element must precede the second element in some manner. Also, unless stated otherwise a set of elements may comprise one or more elements

Reference in the specification to “one embodiment,” “preferred embodiment,” “an embodiment,” or “embodiments” means that a particular feature, structure, characteristic, or function described in connection with the embodiment is included in at least one embodiment of the disclosure and may be in more than one embodiment. The appearances of the phrases “in one embodiment,” “in an embodiment,” “in embodiments,” “in alternative embodiments,” “in an alternative embodiment,” or “in some embodiments” in various places in the specification are not necessarily all referring to the same embodiment or embodiments. The terms “include,” “including,” “comprise,” and “comprising” shall be understood to be open terms and any lists that follow are examples and not meant to be limited to the listed items.

Referring in general to the following description and accompanying drawings, various embodiments of the present disclosure are illustrated to show its structure and method of operation. Common elements of the illustrated embodiments may be designated with similar reference numerals.

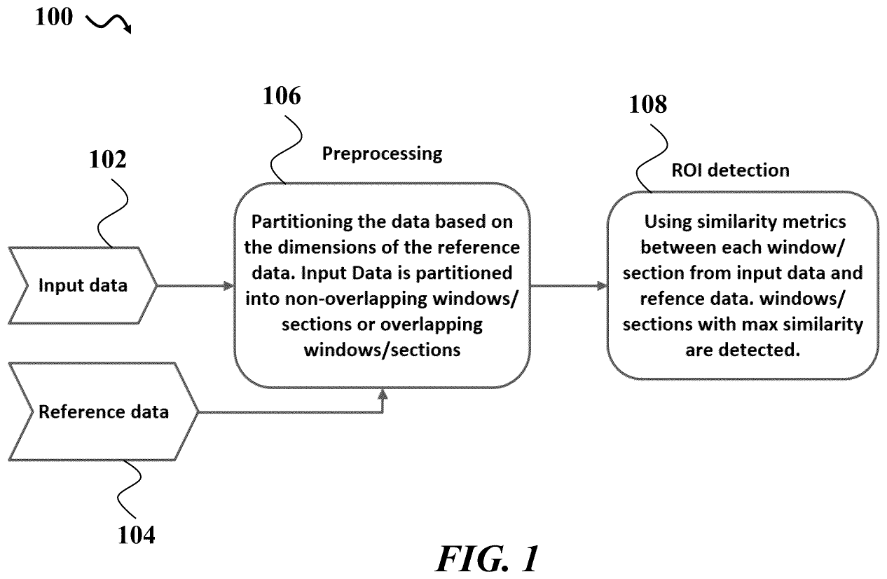

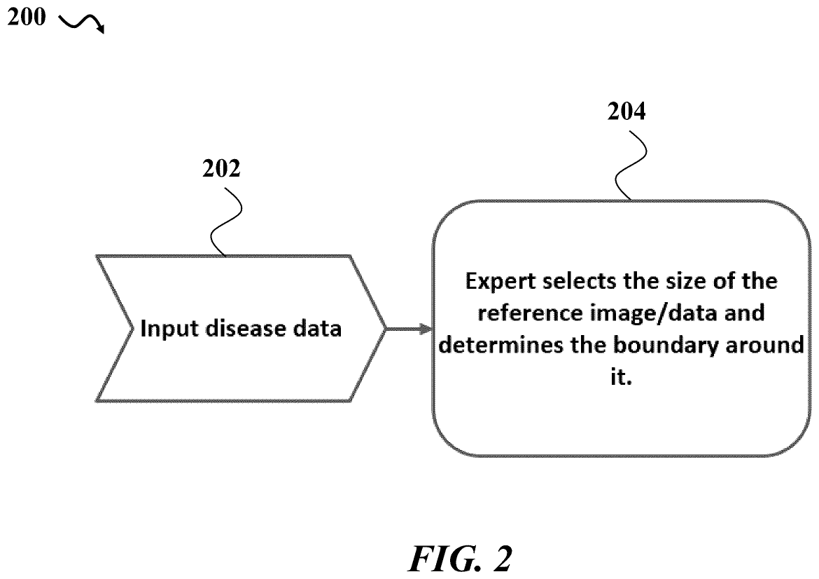

Accordingly, the relevant descriptions of such features apply equally to the features and related components among all the drawings. For example, any suitable combination of the features, and variations of the same embodiment, described with components illustrated in FIG. 1, can be employed with the components of FIG. 2, and/or vice versa. This pattern of disclosure applies equally to further embodiments depicted in subsequent figures and described hereinafter. It should be understood that the figures presented are not meant to be illustrative of actual views of any particular partition of the actual structure or method but are merely idealized representations employed to more clearly and fully depict the present invention defined by the claims below.

### Definitions

As used in this specification and the appended claims, the singular forms “a,” “an,” and “the” include plural referents unless the content clearly dictates otherwise. As used in this specification and the appended claims, the term “or” is generally employed in its sense including “and/or” unless the context clearly dictates otherwise.

In the following description, for the purposes of explanation, numerous specific details are set forth in order to provide a thorough understanding of embodiments of the present technology. It will be apparent, however, to one skilled in the art that embodiments of the present technology may be practiced without some of these specific details.

The techniques introduced here can be embodied as special-purpose hardware (e.g. circuitry), as programmable circuitry appropriately programmed with software and/or firmware, or as a combination of special-purpose and programmable circuitry. Hence, embodiments may include a computer-readable medium having stored thereon instructions which may be used to program a computer (or other electronic devices) to perform a process.

The computer readable medium described in the claims below may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain or store a program for use by or in connection with an instruction execution system, apparatus, or device.

A computer readable signal medium may include a propagated data signal with computer readable program PIN embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program PIN embodied on a computer readable medium may be transmitted using any appropriate medium, including but not limited to wireless, wire-line, optical fiber cable, radio frequency, etc., or any suitable combination of the foregoing. Computer program PIN for carrying out operations for aspects of the present invention may be written in any combination of one or more programming languages, including an object oriented programming language such as Java, C#, C++, Python, MATLAB, and/or the like and conventional procedural programming languages, such as the “C” programming language or similar programming languages.

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computing device, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

As used herein, the term “communicatively coupled” refers to any coupling mechanism configured to exchange information (e.g., at least one electrical signal) using methods and devices known in the art. Non-limiting examples of communicatively coupling may include Wi-Fi, Bluetooth, wired connections, wireless connection, quantum, and/or magnets. For ease of reference, the exemplary embodiment described herein refers to Wi-Fi and/or Bluetooth, but this description should not be interpreted as exclusionary of other electrical coupling mechanisms.

As used herein, the terms “about,” “approximately,” or “roughly” refer to being within an acceptable error range (i.e., tolerance) for the particular value as determined by one of ordinary skill in the art, which will depend in part on how the value is measured or determined (e.g., the limitations of a measurement system), (e.g., the degree of precision required for a particular purpose, such as detecting an abnormal presence within at least one dataset). As used herein, “about,” “approximately,” or “roughly” refer to within ±25% of the numerical.

All numerical designations, including ranges, are approximations which are varied up or down by increments of 1.0, 0.1, 0.01 or 0.001 as appropriate. It is to be understood, even if it is not always explicitly stated, that all numerical designations are preceded by the term “about”. It is also to be understood, even if it is not always explicitly stated, that the compounds and structures described herein are merely exemplary and that equivalents of such are known in the art and can be substituted for the compounds and structures explicitly stated herein.

Wherever the term “at least,” “greater than,” or “greater than or equal to” precedes the first numerical value in a series of two or more numerical values, the term “at least,” “greater than” or “greater than or equal to” applies to each of the numerical values in that series of numerical values. For example, greater than or equal to 1, 2, or 3 is equivalent to greater than or equal to 1, greater than or equal to 2, or greater than or equal to 3.

Wherever the term “no more than,” “less than,” or “less than or equal to” precedes the first numerical value in a series of two or more numerical values, the term “no more than,” “less than” or “less than or equal to” applies to each of the numerical values in that series of numerical values. For example, less than or equal to 1, 2, or 3 is equivalent to less than or equal to 1, less than or equal to 2, or less than or equal to 3.

### Multi-Field Data Analysis System

The present disclosure pertains to a system and method for automatically detecting and/or identifying at least one abnormal presence within at least one dataset. As such, in an embodiment, the multi-field data analysis system (hereinafter “system”) may comprise a computing device comprising at least one processor, such that the computing device may be communicatively coupled to a display device. Additionally, in this embodiment, the system may be configured to retain at least one subject dataset, at least one subject image, at least one target sub-image, at least one reference image, and/or at least one reference sub-image within a memory of the computing device. Moreover, the system may be configured to determine the size, location, and/or shape of the at least one abnormal presence within the dataset. Accordingly, in order to find the size, shape, and/or location of the at least one abnormal presence, the processor may be configured to utilize at least one similarity metric known in the art. For example, in an embodiment, the computing device, via the at least one processor, may utilize SSIM and/or Mean Square Error (hereinafter “MSE”) algorithms and/or metrics to evaluate the similarity between the at least one subject dataset and the at least one reference dataset. In this manner, while these two metrics may be integrated within the system, the system may not be limited to only these metrics, and, as such, the system may utilize any similarity metric known in the art to determine and/or identify the at least one abnormal presence within the at least one image of the at least one dataset.

FIG. 1 depicts an exemplary process 100 for identifying at least one abnormal presence within at least one dataset, according to an embodiment of the present disclosure. First at step 102 of exemplary process 100, in this embodiment, the system may be configured to input at least one subject dataset (e.g., a target image and/or a target sub-image) and/or at least one reference data (e.g., a reference image and/or a reference sub-image). Accordingly, in this embodiment, as stated above the system may be configured to store the at least one subject dataset and/or the at least one reference data in the memory of the computing device of the system. Additionally, the reference data may comprise the at least one abnormal presence to be referenced by the system during detection.

As such, FIG. 2 depicts an exemplary process 200 for reference data selection within the system, according to an embodiment of the present disclosure. As such, at step 202, of reference data exemplary process 200, in this embodiment, the system may be configured to determine based on the at least one reference dataset (e.g., disease data and/or healthy data) an appropriate marker (e.g., size, shape, location, and/or coloration of the reference image), in addition to an appropriate boundary of the reference image. In this manner, at step 204, the system may be configured to filter at least one portion of the at least one reference dataset based on the at least one preference as determined by the system. Moreover, in this embodiment, the system may comprise at least one user interface, such that the user interface may be communicatively coupled to the computing device of the system. Accordingly, at step 204, at least one user may input at least one preference and/or determine the size, shape, location, colorization, and/or boundary of the reference image via the at least one user interface.

Referring again to FIG. 1, next, at step 106 of exemplary process 100, in an embodiment, the at least one reference dataset and/or the at least one subject dataset may be preprocessed by the processor of the computing device. As such, in this embodiment, based on the reference data, the at least one appropriate marker may be selected by the processor of the system, including but not limited to an optimal size, a location, a shape, and/or domain (e.g., spatial domain, DCT and/or DWT), based on the at least one reference dataset.

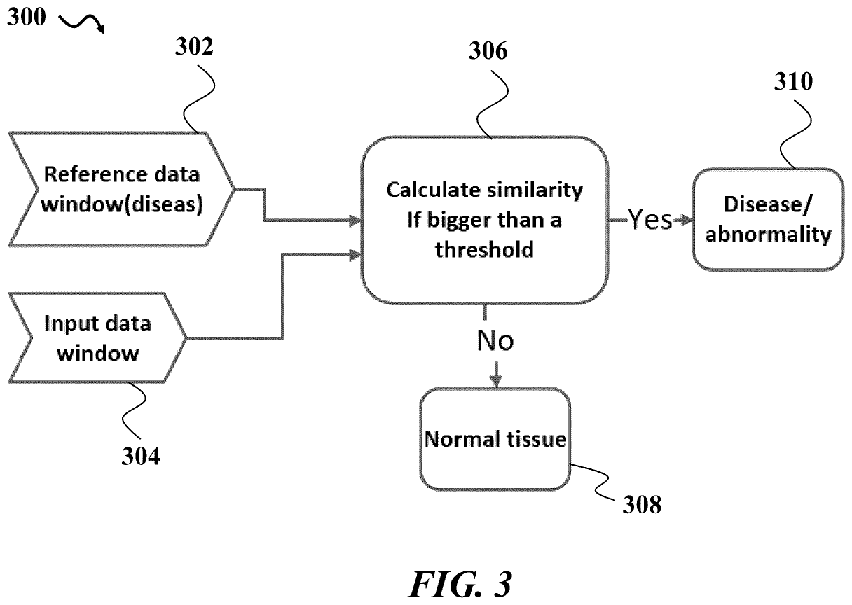

In this manner, FIG. 3, in conjunction with FIG. 1, depicts an exemplary process 300 of a subsection selection within step 106 of FIG. 1, based on a max similarity between inputted data and reference data, according to an embodiment of the present disclosure. As such, in an embodiment, the selection of the at least one subject sub-images comprising the at least one abnormal presence may depend on the reference dataset and/or the subject dataset and may be subjective to the application. Moreover, in this embodiment, at step 302 and step 304 of exemplary process 300, at least one portion of at least one subject dataset and/or the at least one reference dataset may be selected by the processor of the computing device of the system to determine a similarity between the selected portion of the at least one reference dataset and the selected portion of the at least one subject dataset. Next, at step 306, in this embodiment, the processor of the system may be configured to calculate a similarity between the selected portion of the at least one subject dataset (e.g., at least one subject sub-image) and the selected portion of the at least one reference dataset (e.g., at least one reference sub-image), such that the system may be configured to determine if the calculated similarity may be greater than or equal to a predetermined similarity threshold.

In this manner, in an embodiment, the system may be configured to implement and/or utilize any similarity metric known in the art, including but not limited to SSIM. For example, as known in the art, SSIM may be used as a metric to measure the similarity between the two given images, and is often used as a loss function in a gradient-based implementation.

Additionally, as known in the art, SSIM was introduced as an alternative framework based on the structural information of the image. The idea came from the human visual perception, which is highly adapted for extracting structural information from a scene. As such, SSIM calculates the similarity between two images based on the degradation of structural information.

In an embodiment, the system comprises an SSIM in order to calculate the similarity between the selected portion of the at least one subject dataset and the selected portion of the at least one reference dataset. In this manner, the processor of the system, via the SSIM metric, may be configured to evaluate quality, based on the similarity between image statistics (mean u, variance 2, and covariance oxy). As such, SSIM may be the product of three terms: luminance, contrast, and/or structure. The calculation, as provided below, in Equation (5), denotes “x” as the selected portion of the at least one reference dataset (e.g., the at least one reference image and/or sub-image) and/or “y” as the selected portion of the at least one subject dataset (e.g., the at least one subject image and/or sub-image). In addition, “C” represents constants in the calculations, which may be used for numerical stability to avoid division by a zero and/or are dependent on the dynamic range. In this embodiment, the standard SSIM formula may use values for those constants of “C”, for example: (1) C1=(0.01*L) 2; (2) C2=(0.03*L) 2; and (3) C3=C2/2. Furthermore, the importance of the luminance, contrast, and/or structure terms may also be weighted using the “α”, “β”, and/or “γ” exponents, respectively, which may be traditionally set to 1. As such, in this embodiment, Equation (1)-Equation (5), as integrated by the system, are provided below:

$$l ( x , y ) = \frac{2 {μ}_{x} {μ}_{y} + C 1}{{{μ}_{x}}^{2} + {{μ}_{y}}^{2} + C 1} \qquad ( 1 )$$

$$C ( x , y ) = \frac{2 {σ}_{x} {σ}_{y} + C 2}{{{σ}_{x}}^{2} + {{σ}_{y}}^{2} + C 2} \qquad ( 2 )$$

$$S ( x , y ) = \frac{{σ}_{x y} + C 3}{{σ}_{x} {σ}_{y} + C 3} \qquad ( 3 )$$

$$SSIM ( x , y ) = {[ l ( x , y ) ]}^{α} \cdot {[ C ( x , y ) ]}^{β} \cdot {[ S ( x , y ) ]}^{γ} \qquad ( 4 )$$

$$SSIM ( x , y ) = \frac{( 2 {μ}_{x} {μ}_{y} + C 1 ) ( 2 {σ}_{x y} + C 2 )}{( {{μ}_{x}}^{2} + {{μ}_{y}}^{2} + C 1 ) ( {{σ}_{x}}^{2} + {{σ}_{y}}^{2} + C 2 )} \qquad ( 5 )$$

In this manner, in an embodiment, the system may be configured to determine a perfect correspondence between the selected portion of the at least one subject dataset and the selected portion of the at least one reference dataset when Equation (5) (i.e., the SSIM metric) may output a result of 1.

Accordingly, in an embodiment, if the calculated similarity may be greater than or equal to the predetermined similarity threshold, the system may be configured to output to at least one user, via the display device and/or any notification device known in the art in communicatively coupled to the computing device of the system, that the at least one abnormal presence may be present within the selected portion of the at least one subject dataset. In this manner, if the calculated similarity is less than the predetermine similarity threshold, the system may be configured to output to the at least one user, via the display device and/or any notification device known in the art in electrical communication with the computing device of the system, that the at least one abnormal presence may not be present within the selected portion of the at least one subject dataset.

Moreover, referring again to FIG. 3, as shown at step 302 of exemplary process 300, within the at least one subject dataset, in an embodiment, at least one subject sub-image may be selected by the processor and/or the at least one user, via the at least one user-interface, such that the at least one subject sub-image may be determined as comprising the at least one abnormal presence if it has a predetermined max similarity with the at least one reference sub-image of the at least reference dataset based on the similarity metric. As such, in an embodiment, the predetermined max similarity may be determined based on a threshold determined by the system and/or the at least one user. The threshold may be calculated based on the at least one reference dataset and/or the at least one abnormal presence to be searched for by the system. For example, in an embodiment, the threshold may depend on whether the at least one abnormal presence may be a disease in general and/or whether the at least one abnormal presence is a specific type of abnormality (e.g., a virus and/or a tumor). Accordingly, in each case, in an embodiment, the threshold may be selected to adapt to the need of the system, the at least one reference dataset and/or the at least one subject dataset.

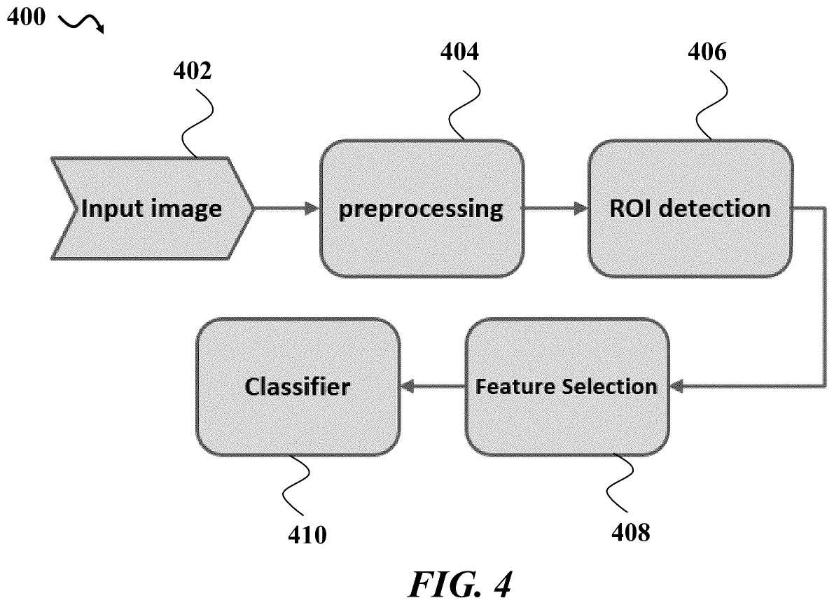

Finally, referring again to FIG. 1, in conjunction with FIG. 4, in step 108 of exemplary process 100, in an embodiment, the processor may be configured to perform a Region of Interest (hereinafter “ROI”) detection. As such, in this embodiment, the system may be configured to activate and/or utilize at least one correlation method and/or at least one similarity metric. As such, once the at least one correlation method and/or similarity metric have been determined, the system may be configured to detect the ROI while retaining the parameters (e.g., optimal size, location, shape, and/or structural characteristics). Accordingly, in this embodiment, the system may be configured to transmit the data to the display device in electrical communication with the computing device, such that the system may be configured to highlight the ROI and/or place a bounding box surrounding the ROI within the subject image.

As shown in FIG. 4, in an embodiment, before the system may begin a classification processes, as shown in step 402, step 404, and step 406 of an exemplary process 400, respectively, the system may first identify the ROI. Next, at step 408, the system may extract at least one feature from the ROI, as determined by at least one deep learning algorithm of the system and/or by the at least one user, via the at least one user-interface. Finally, at step 410, the processor may be configured to transmit the at least one selected feature to at least one classifier to determine the type of object within the ROI.

Furthermore, one of the many advantages of the system is that the system may be configured to optimize preprocessing the data and/or finding the ROI within the data (e.g., tumor classification). As such, in an embodiment, the system may be configured to slice (e.g., crop) at least a portion of the at least one subject sub-image and/or the at least one reference sub-image, such that the system may enable the detection of slices that contain the at least one abnormal presence within the at least one subject sub-image and/or the at least one reference sub-image, while referencing in part or in whole the at least one subject dataset and/or the at least one reference dataset (e.g., MRI, CT-Scan, and/or EKG of a patient).

Additionally, another aspect of the system may comprise segmentation, such that the system may also be configured to detect and/or highlight the size, shape, and/or location (i.e., features) of the at least one abnormal presence in the at least one slice, optimizing the feature extraction of the at least one abnormal presence, thereby increasing classification accuracy. Accordingly, in some embodiments, the processor of the system may be configured to implement at least one segmentation algorithm (e.g., region growing segmentation), such that the at least one abnormal presence may be segmented without the computational complexity of the current deep learning algorithms. Additionally, in some embodiments, the system may integrate at least one deep learning algorithm with the at least one segmentation algorithm, such that the system may be configured to automatically determine the ROI and/or the appropriate segmentation of the at least one abnormal presence within the at least one subject dataset.

For example, in some embodiments, when identifying a tumor in the brain, since the brain is naturally symmetric and a tumor within the brain usually occurs in the left or right-hand side of the brain, the system may not require the at least one reference sub-image and/or the at least one reference dataset. Therefore, the system may be configured to directly apply the detection and/or segmentation of the brain tumor without additional information (i.e., the at least one reference sub-image and/or the at least one reference dataset).

The following example(s) is (are) provided for the purpose of exemplification and is (are) not intended to be limiting.

### EXAMPLES

### Example #1

### Identifying the Presence or Absence of a Brain Tumor in Brain Scan

The two images used are the same except for the tumor region. The similarity measures between the two images are calculated in two ways. First, finding the similarity without any subdivision in images, and second, the two images being divided into sections (e.g., either overlapping or non-overlapping windows) where the similarity between each set of corresponding windows in two images is calculated. Therefore, minimum similarity between the two sub images (e.g., windows), determines the location of the whole tumor or partial part of the tumor. Since the images are sectioned, this may allow for indication of whereabouts of the tumor. Once the “least similarity set of k windows” (e.g., the k number of windows that have less similarity between them) is determined, the system may go back and adjusts the size of the window in the vicinity of the found locations.

The system may also apply both the first and second calculations in Discrete Cosine Transform (i.e., DCT), and Wavelet domains as well as spatial domain.

In order to demonstrate the technique, a sample brain image containing tumor is selected from the publicly available dataset from the Repository of Molecular Brain Neoplasia Data (REMBRANDT) (obtained from cancer imaging archive). This dataset contains 4404 MRI images from 80 patients (T1 weighted contrast enhanced axial) in total. Each patient is diagnosed with one of the three grades of glioma (Grade II, Grade III, and Grade IV) tumors. 80 patients MRI images with 80 labels (1 label per patient) is used. All images are resized to 256×256 and then the rest of the processing is applied.

For demonstration purposes the applied technique is shown on the sample set of images. SSIM and MSE are used to evaluate the results. The objective here is to find out the conditions under which the tumor (i.e., object of interest or abnormal presence) is detected and the ones that fail using the similarity metrics.

The dataset at hand, only has images with tumor. Therefore, the at least one user manually segments the tumor for the system to create the clean image (image without tumor). This clean image is used as a reference image and the image with tumor serves as a sample image. Note that the at least one user manually creates the reference image for the system to show the validity and ability of the proposed technique.

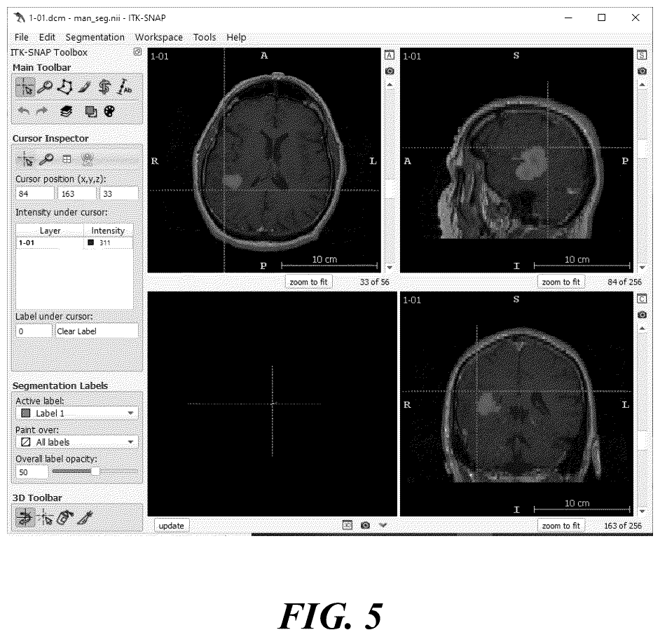

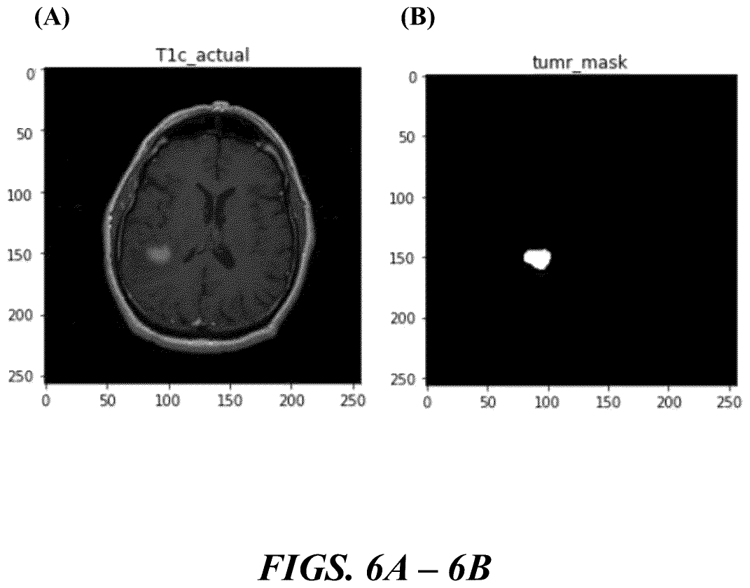

ITK snap software is used to visualize and segment the tumor region manually. FIG. 5 shows the view of this software, along with the segmented region overlayed on top of it. The original image and the extracted tumor mask are shown in FIG. 6A and FIG. 6B.

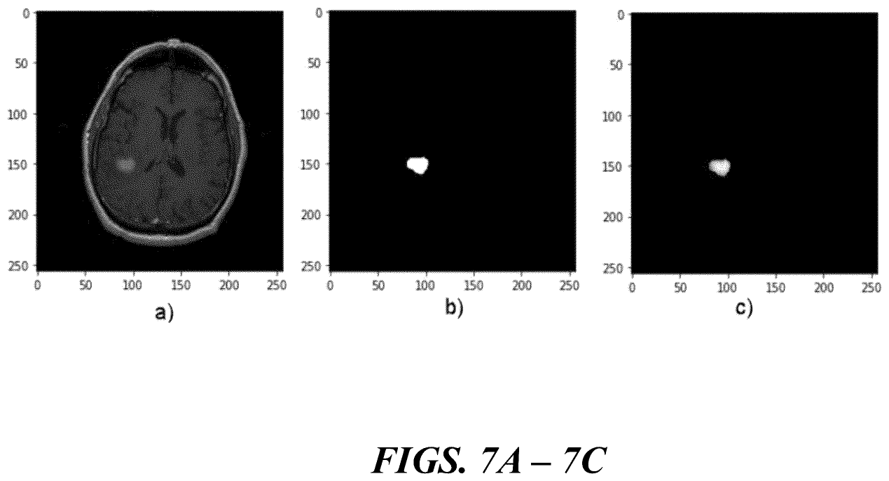

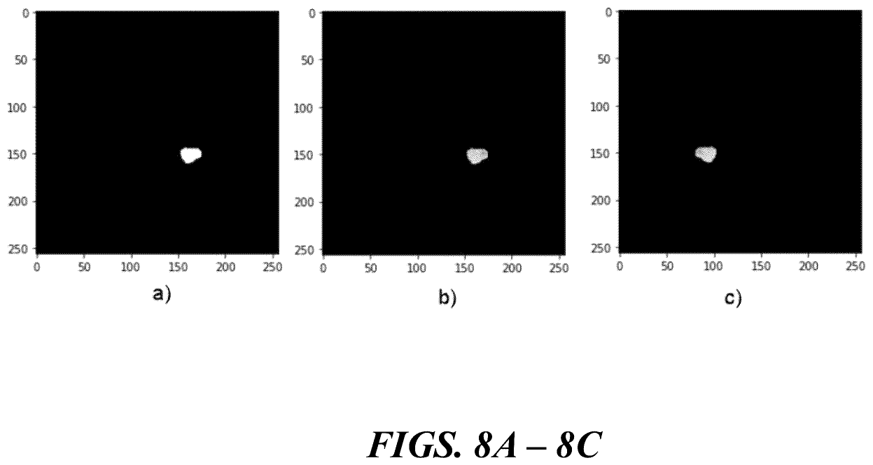

FIGS. 7A-FIG. 9C depict the process of obtaining the clean image from tumorous image. Here, the system may implement Python programming and/or any programming code known in the art for implementation. Since the brain is symmetric, the system may be configured to replace the tumor region with clean tissue region from the mirrored side. Therefore, as shown in FIG. 8A, the first the tumor mask may be inverted, then the inverted mask may be applied (i.e., multiplied) with the image to extract the healthy tissue region, as shown in FIG. 8B. Next, as shown in FIG. 8C, this healthy tissue may be inverted back to be replaced in the place of tumor. As such, the system may define this as “healthy region mimic.”

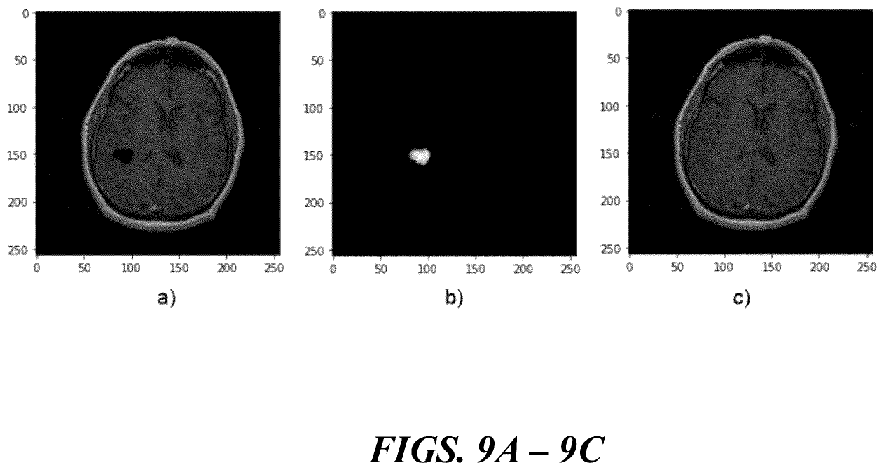

Next, as shown in FIG. 9A, the tumor region in the first image may be removed (e.g., replaced with zero). This is defined as “image with hole” as shown in FIG. 9B. Finally, as shown in FIG. 9C, the system may add the two images (e.g., “image with hole” and “healthy region mimic”) to get the clean image.

For the sake of clarity, the following notations are defined and used throughout the example: (1) “I1” represents the original image with tumor; (2) “I2” represents the tumor itself; (3) “I3” represents the image without tumor (e.g., the tumor is manually removed); and (4) “I4” represents the healthy tissue corresponding to tumor region.

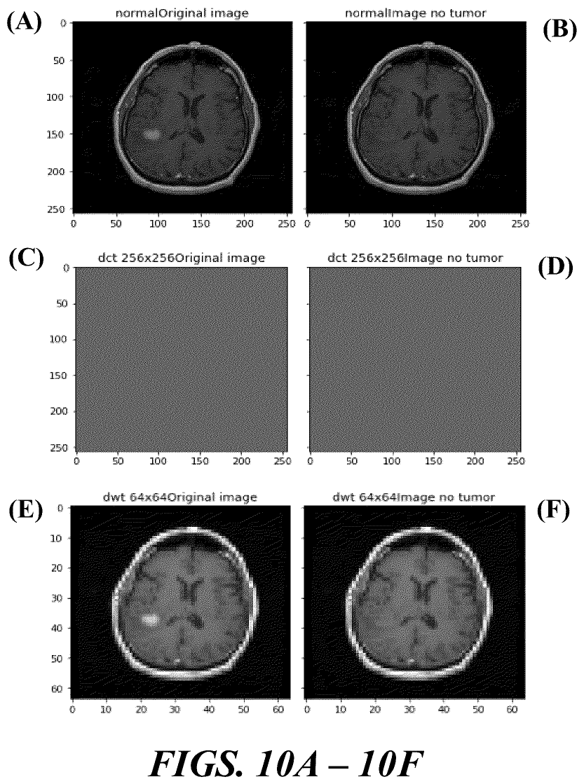

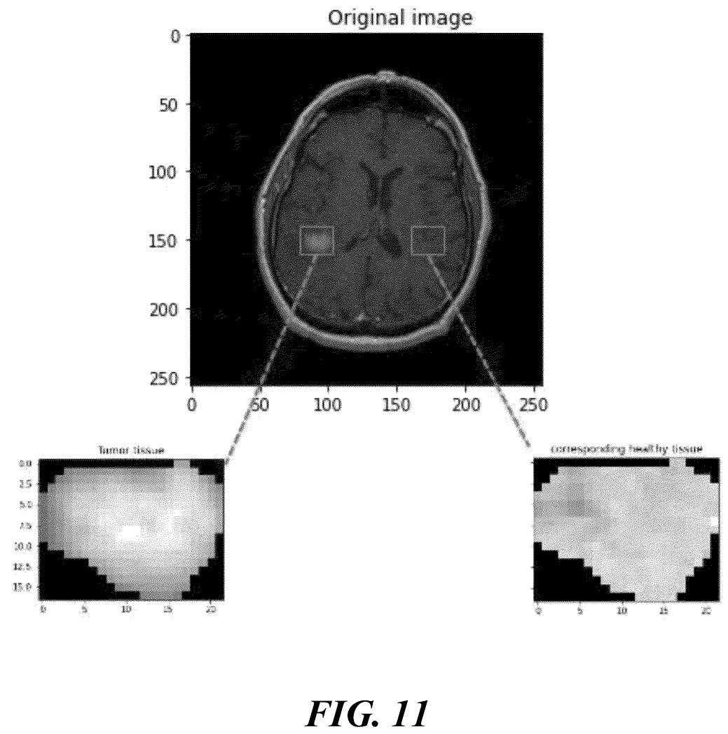

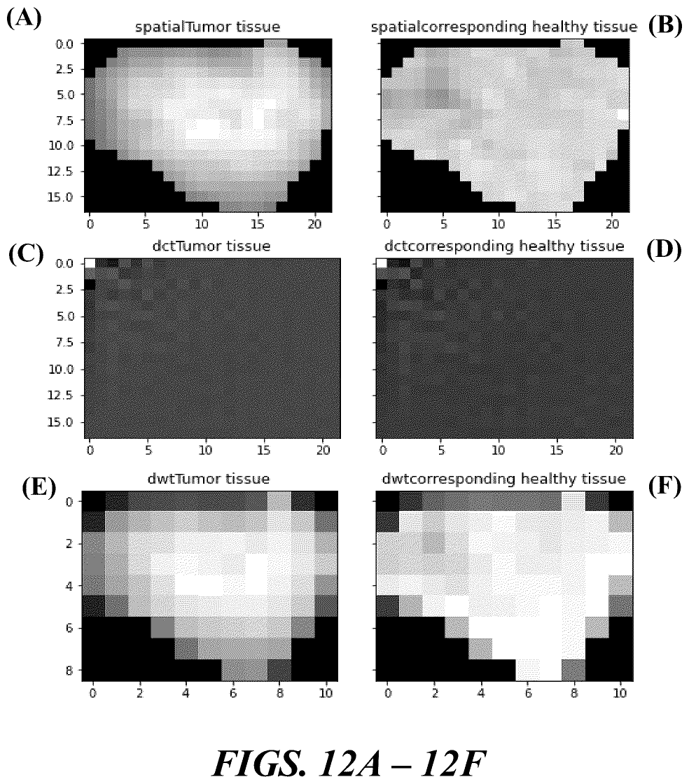

As shown in FIGS. 10A-10F, I1 and I3 may be from the first set of images, and I2 with I4 may be from the second set of images (as shown in FIG. 11 and FIGS. 12A-12F). Experiments have been conducted on these set of images and explained in the following sections.

First the similarity of the two set of images may be determined by calculating two aforementioned metrics for the whole pair of images. a single value for each metric may be calculated in this scenario. This experiment is conducted in spatial domain as well as in DCT and/or wavelet domains.

It is worth mentioning that the similarity between an image and itself in terms of SSIM and MSE metrics are 1 and 0 respectively. Which indicates complete similarity. The result of comparing the 2 sets of images in 3 different domains are summarized in TABLE 1.

TABLE 1

| | Domain | | |
|---|---|---|---|
| Image Sets | Spatial | DCT | DWT |
| I1, I3 | SSIM = 1 | SSIM = 1 | SSIM = 0.98 |
| | MSE = 6.59 | MSE = 6.59 | MSE = 0 |
| 12, I4 | SSIM = 0.4 | SSIM = 0.97 | SSIM = 0.91 |
| | MSE = 1153.91 | MSE = 1153.91 | MSE = 0.02 |

From the results in TABLE 1, it is obvious that when the region of comparison is smaller (e.g., I2 and/or I4 comparison) and/or when there is less similarity between the two images the SSIM metric may be capable of highlighting the difference.

For instance, in DCT case when the images I1 and I3 may be compared the SSIM metric does not show any difference between the two (e.g., SSIM=1) while there is a slight difference (e.g., only the tumor region). In contrast, when only the tumor region and the corresponding healthy region are compared (e.g., I2, and I4), the SSIM is 0.97 which shows the difference between the two. This means that the smaller the region of comparison the better discrimination between the two image is. Also, this can be seen from FIGS. 10A-10F and FIGS. 12A-12F in second row in which the DCT transform of whole image doesn't differ among I1, I3 in FIGS. 10A-10F, while the difference between the I2, I4 is obvious in FIGS. 12A-12F.

This led to sectionizing the images and comparing the corresponding sections with each other. Here there are two choices for the system: 1st choice: applying the transform on whole image and/or then sectionizing the resulted transform and comparing the sections. 2nd choice: sectionize the images first and/or then apply the transform on each section and compare the results.

As the 2nd choice may be a better option for the system, especially in the case of DCT which the spatial information is lost after applying the transformation so there will be no way of telling the resulted transform domain image corresponds to which part of the image. Moreover, the 1st and/or 2nd choice doesn't make a difference in spatial domain since there is no transform involved. Also, in order to determine the location of the tumor system may be configured to sectionize each of the sets of images, especially in the case of spatial domain as well as DCT domain.

Both choices were tested and the results are summarized in TABLE 2. The patch size used here is 15×15 with no overlapping windows. Note that the window size can also be changed and optimized and 15×15 is selected as an example.

For the case of I2 and/or I4, since the size of each one of them is 20×20 at most, the system may not be required to partition them and it is already shown that the SSIM may be capable in detecting the difference between these two images.

Each one of images I1 and I3 are sectioned into m×m non-overlapping windows. The corresponding windows from each image are compared and the similarity metric for each set is calculated. The system may determine L number of windows (e.g., hence, L SSIM metric), the k least values of SSIM will locate the tumor. Here, m and k are selected to be 15, and 4 respectively.

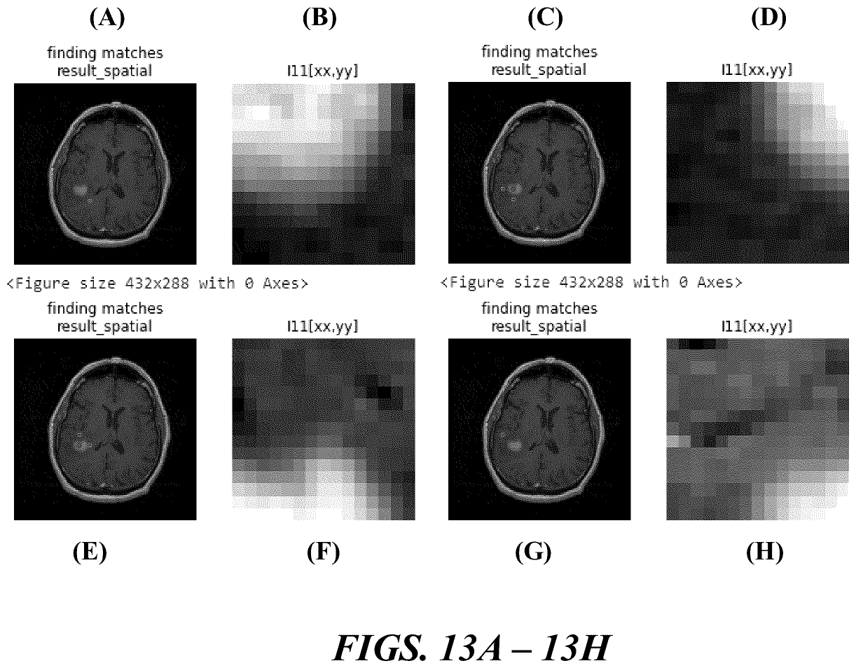

Therefore, k=4 sections with least similarity between the two images are found and the corresponding SSIM, MSE values are gathered in TABLE 2. Also, the locations of the corresponding sections are shown in FIGS. 13A-13H, which indicate the four (4) sections that tumor has appeared.

Following the same procedure, the system may first applies DCT on whole image. Next, the system may be configured to divide the image into sections (e.g., either overlapped or non-overlapped windows), and/or then the system may calculate the SSIM metric for each two corresponding sections. Further, in order to see whether the tumor information/location is captured, the system may convert the DCT image back to spatial domain. Since the spatial domain is lost when the system applies DCT, converting back to spatial domain does not make a clear difference. In other words, the bunch of shown coefficients in the DCT domain doesn't point to a specific location in the original image (e.g., spatial image).

Therefore, in the case of DCT, first, the system may sectionize both images (e.g., non-overlapping windows are used here) and/or then the system may be configured to apply the transform on each section. Next, the SSIM may be calculated for each pair of corresponding sections individually. The results for 4 sections with least similarity between the two images with the corresponding SSIM, MSE values are gathered in TABLE 2.

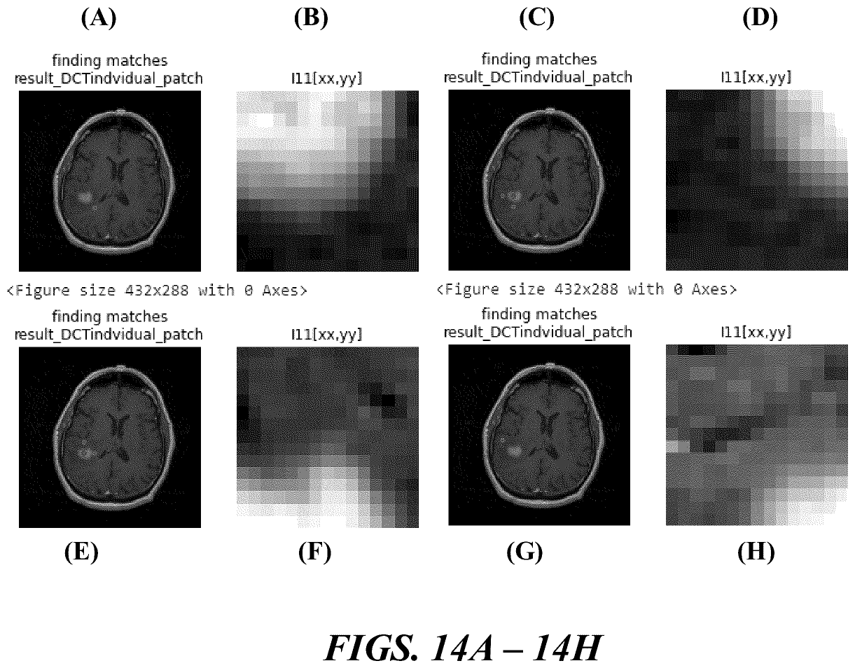

Also, the locations of the corresponding sections are shown in FIGS. 14A-14H, which indicate the 4 sections that tumor has appeared.

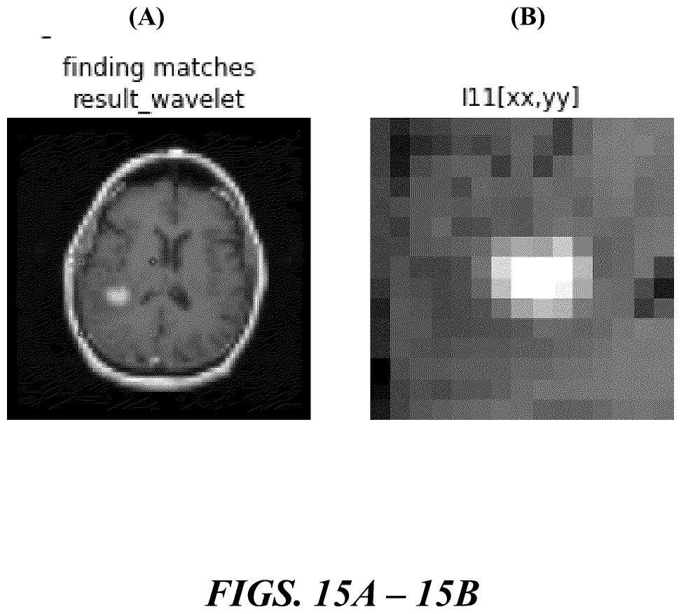

For wavelet domain, first, the system may apply the wavelet on both images and/or then the resulted images from LL band may be divided by the system into a predetermined amount of windows (e.g., 15×15 windows). Accordingly, the metrics may then be calculated. The results of the 4 least similar sections with corresponding metric values are gathered below in TABLE 2. Note that only one of the SSIM values is less than 1 which indicates the tumor being localized in one section only as it is shown in FIGS. 15A-15F.

Since when applying wavelet, the image may be downsized therefore with only one patch of 15×15 the tumor may be localized in the wavelet domain.

Based on the results gathered in TABLE 2, it is obvious that the spatial domain usage of SSIM may provide a more stable results other than DCT. It is also worth noting that using DWT and/or the same window patches as spatial domain may result in finding the tumor in one square patch instead of four (e.g., as in DCT, and spatial domain) This is due to the fact that, the system may be configured to downsize the image when applying the wavelet transform, leading to a smaller image size, therefore the tumor can be localized in one patch. Also, since the spatial information is not lost when applying wavelet transform the tumor can be found in the spatial domain. Moreover, the system may be configured retain the spatial information, such that it is not lost in DCT domain if the system may first sectionize and/or then may apply the transform, as shown previously in FIGS. 14A-14H. Therefore, partitioning may also be the requirement for finding the location of the abnormality if present.

TABLE 2

| | Domain | | |
|---|---|---|---|
| Image Sets | Spatial | DCT | DWT |
| I1, 13 (whole | SSIM = 0.14, | Doesn't really | SSIM = [0.4, |
| image apply | 0.41, 0.73, 0.74] | mean anything | 1.0, 1.0, 1.0] |
| transform, then | MSE = [932.03, | | MSE = [0.005, |
| sectionize and | 437.98, 331.83, | | 0.0, 0.0, 0.0] |
| compare) | 216.21] | | |
| I1, I3 | No change | SSIM = [0.955, | No need to |
| (sectionize | Since there is | 0.957, 0.961, | apply it since |
| first, apply | no transform | 0.973] | it already |
| transform and | involved | MSE = [932.031, | downsizes |
| compare) | | 437.978, 331.831, | the image |
| | | 216.208] | with the DWT |

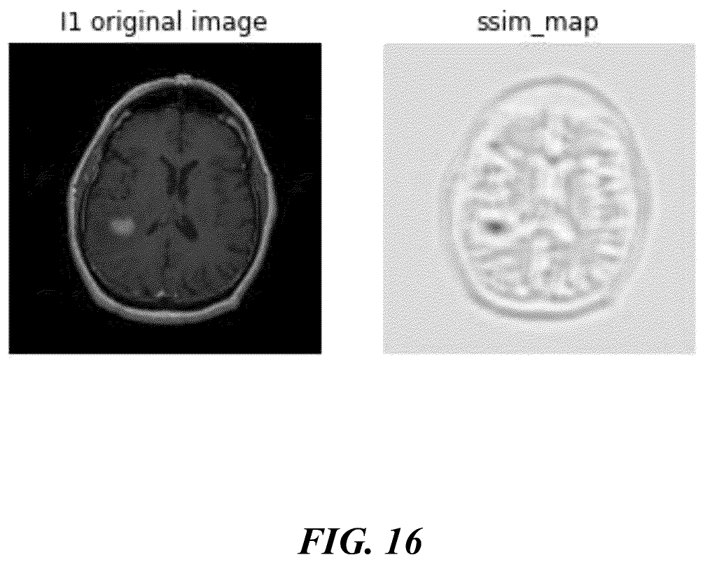

Another approach to the problem is also viewed by halving the two images I1 (e.g., original image with tumor) and I2 (e.g., only the tumor template itself). Here, the system proves that the method proposed may be capable of finding the tumor in the image. Since the two images are not the same size, the system applies the method using overlapping windows. By shifting the template window one row and/or one column at a time. Therefore, by applying the method and/or calculating the similarity metric, the system will have a similarity value for each pixel in the image. The resulted similarity map (e.g., SSIM map) is shown in FIG. 16.

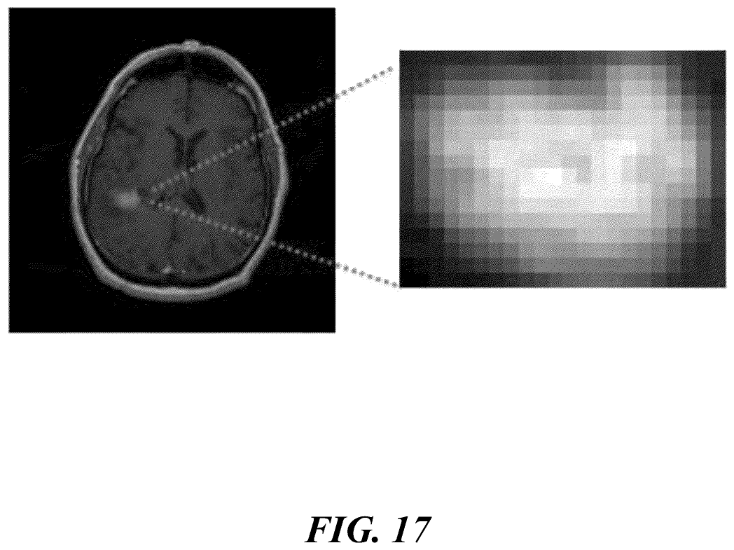

In this image each color represents a number between 0 to 1. Where darker colors are closer to 1 and lighter colors are closer to 0. The tumor location should have SSIM closer to 1 (i.e., max similarity). Also, the location of the tumor based on the max values of the SSIM-map is shown in FIG. 17.

As a result, the method may be capable of finding the tumor location given the tumor itself. Next, the system will examine if the method may be capable of discriminating between the healthy tissue and tumorous tissue. In other words, the system will verify that the healthy tissue does not correlate with tumorous tissue i.e. healthy tissue is not mistakenly detected as tumor.

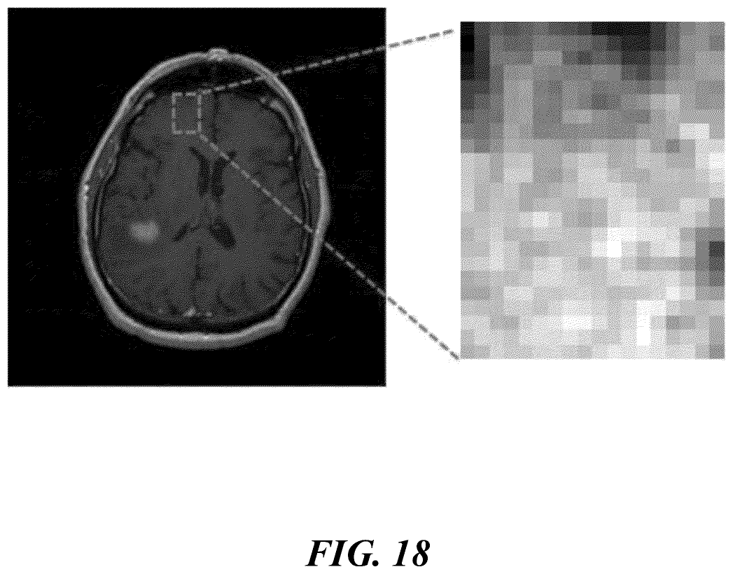

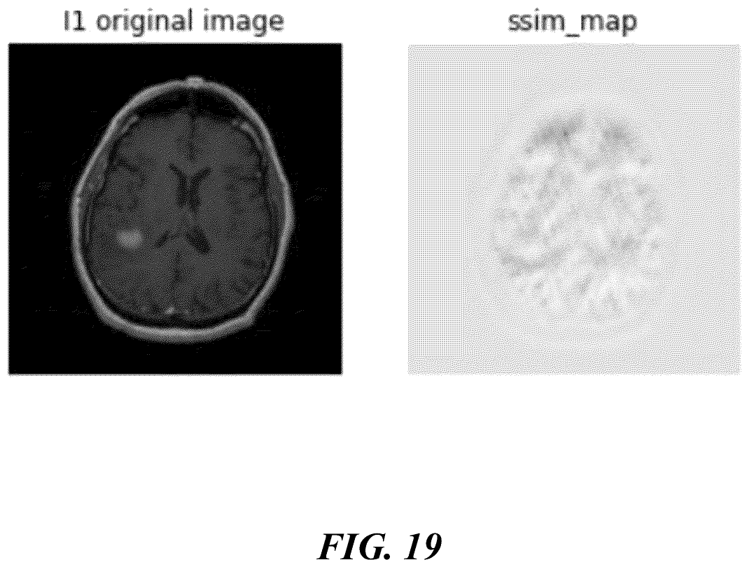

In this case, the system uses healthy tissue as the template image, and I1 (e.g., original image with tumor), as the sample image. Both images are shown in FIG. 18. The resulted SSIM-map from applying the method (e.g., using overlapping windows) is shown in FIG. 19. The dark regions in the SSIM-map show the max similarity between the template and original image, which correspond to normal tissue in the original image. Also the map shows minimum similarity in the tumor regions (e.g., it has lighter colors in the tumor location). Hence, the method may be capable of discriminating between the normal and tumorous images.

Next, the system will determine if the method is capable of finding the tumor location if the template given is from a different grade of tumor.

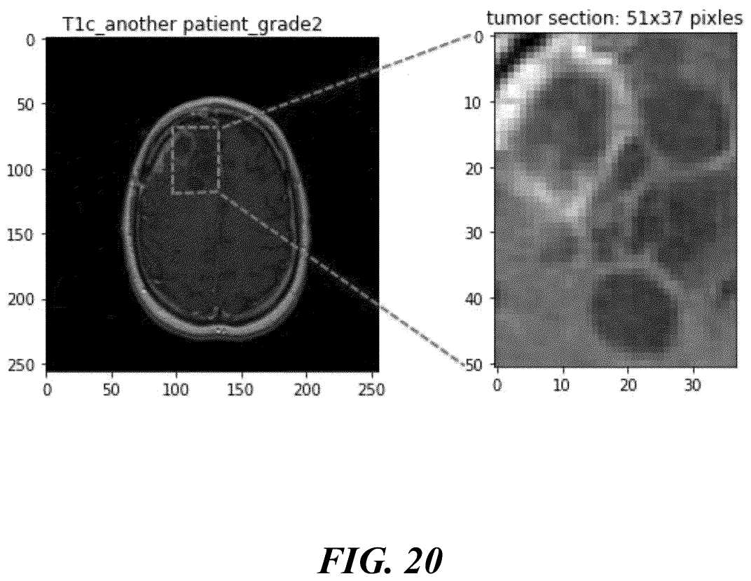

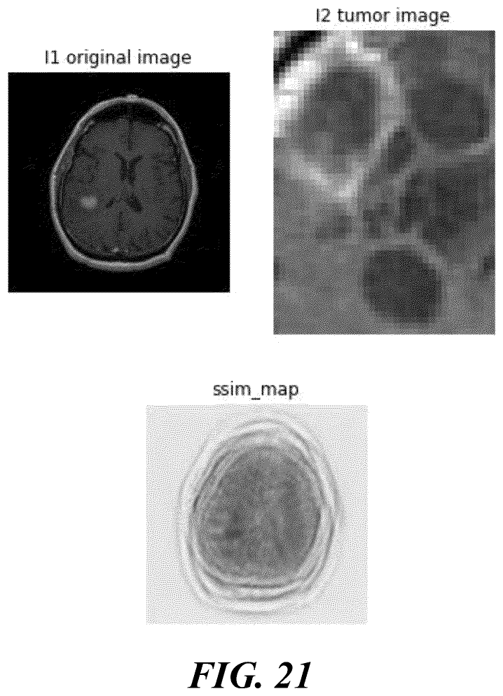

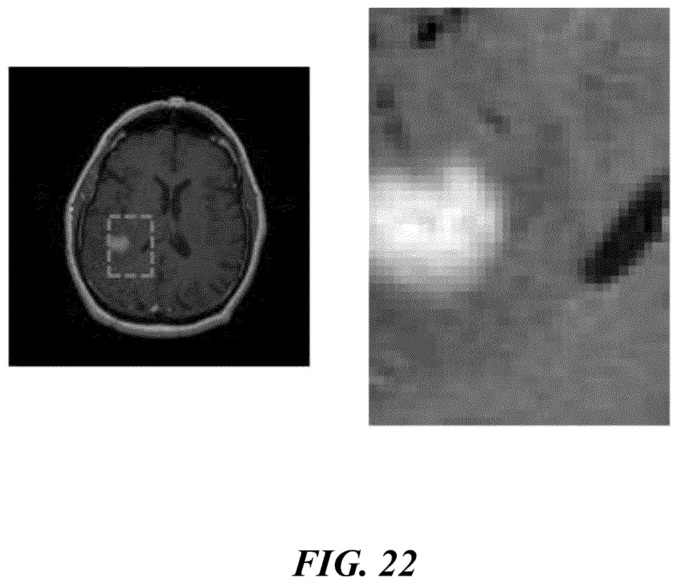

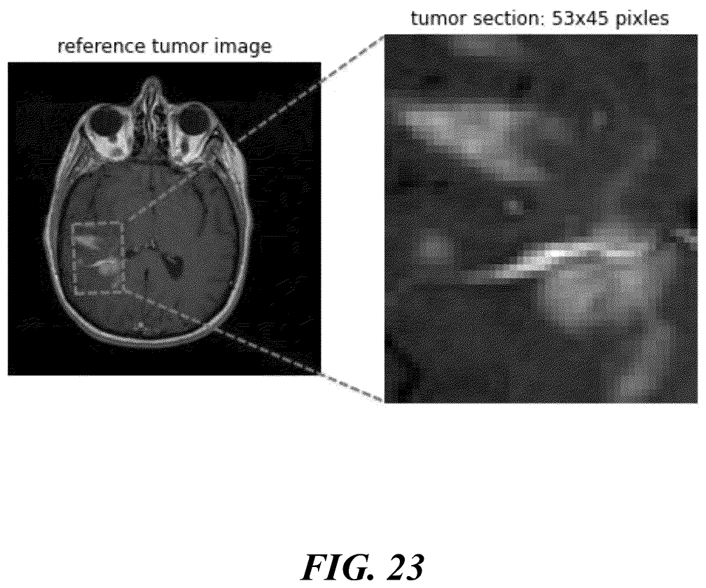

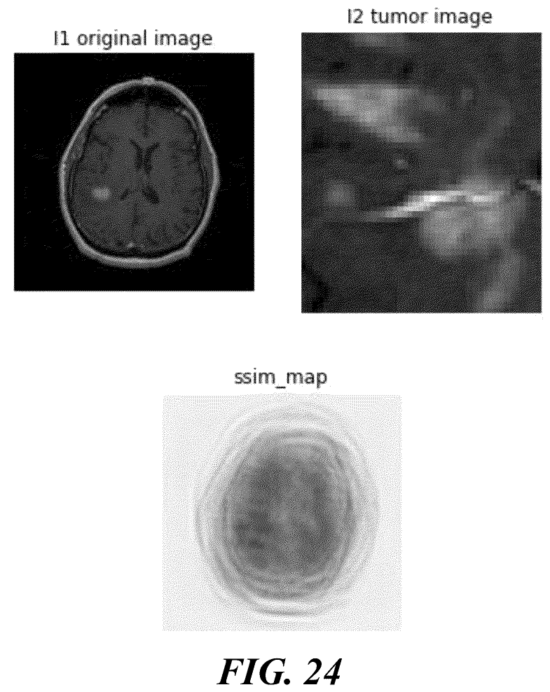

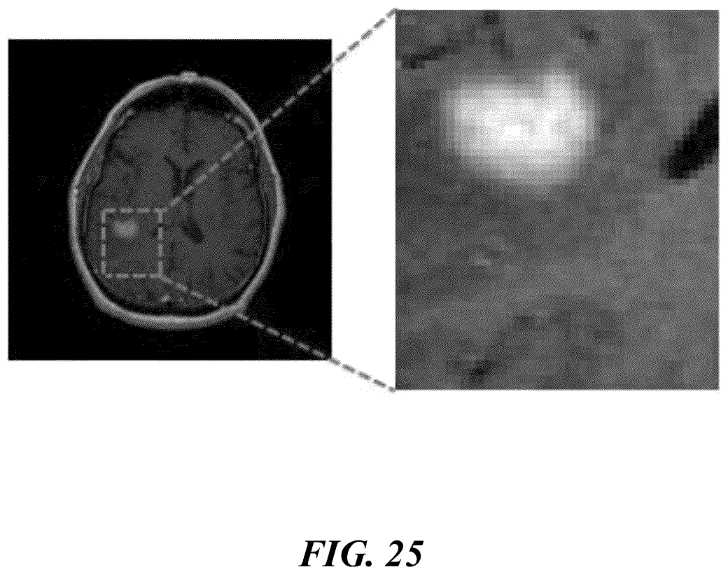

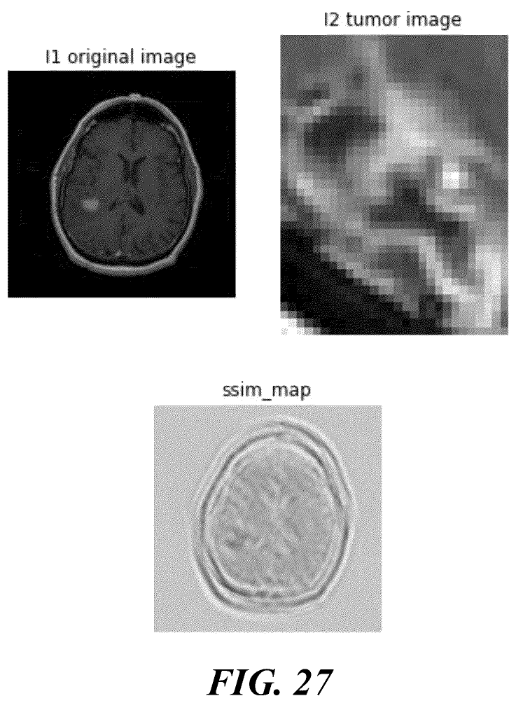

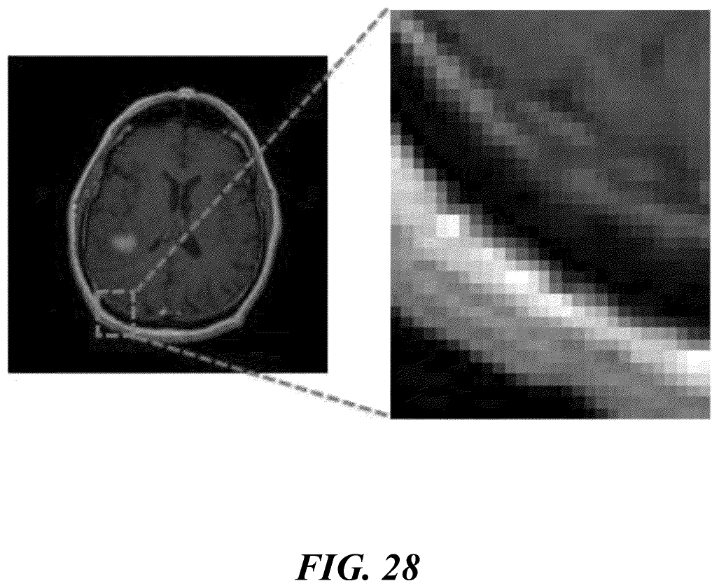

For this part, the system may be configured to implement a plurality of templates (e.g., 3 separate tumor templates), different from the tumor in the original image (e.g., sample image I1). The resulted SSIM-map from applying the method (e.g. using overlapping windows) may be calculated for each 3 cases and the results are shown in FIG. 20-FIG. 28.

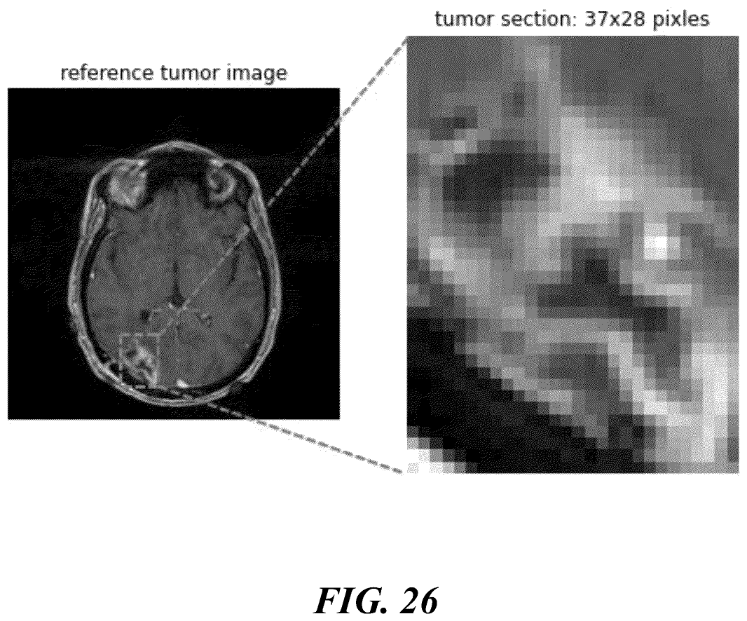

The results show that the system and/or method are capable of detecting and/or localizing the tumor even when the system may be using a different type of tumor in contrast with the tumor in the sample image. Hence, the technique qualifies for detecting the grade of the tumor within the same type. It is also worth mentioning that in case 3 (as shown in FIG. 26-FIG. 28), the system and method may find the max similarity in the edge of sample image instead of localizing the tumor. This is due to the fact that the skull may be present in the tumor template, resulting in high similarity measure between the skull and the tumor template. In order for the system and method to work properly the system may be required to perform skull stripping before applying the method.

The current trend in medical community is to ensure early detection of the tumors in their onset to avoid further difficulties and provide higher quality of life for the patients. Also, this will reduce the cost of medical treatment and increase the survival rate of the patients. Here, in order to find the smallest tumor size that can be detected by the proposed method, at least one user manually selects part of the tumor for the system and the system then substitutes the rest of the tumor with healthy tissue. The smallest size of the tumor, where it can still be detectable by the method was found to be 12×11 pixels. The experiments were conducted using the modified image with this smallest tumor size as in the place of the actual tumor in the original image (11).

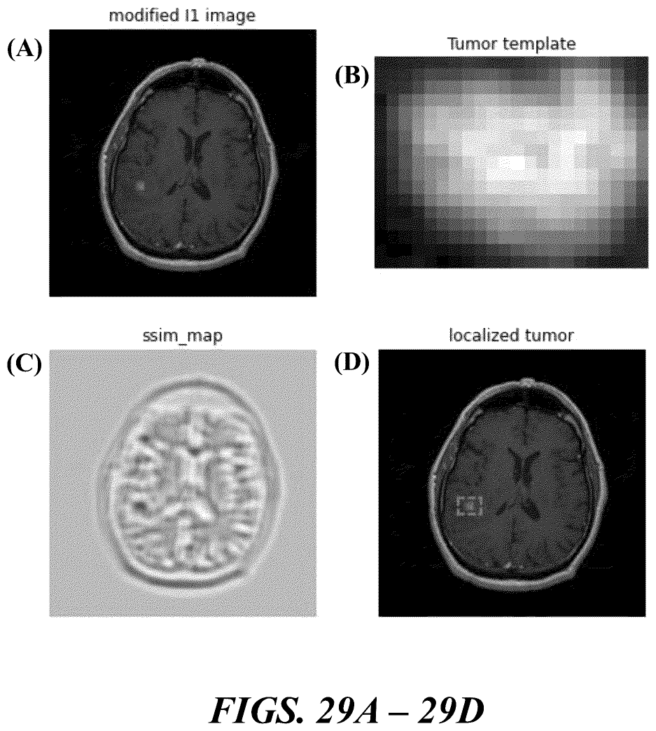

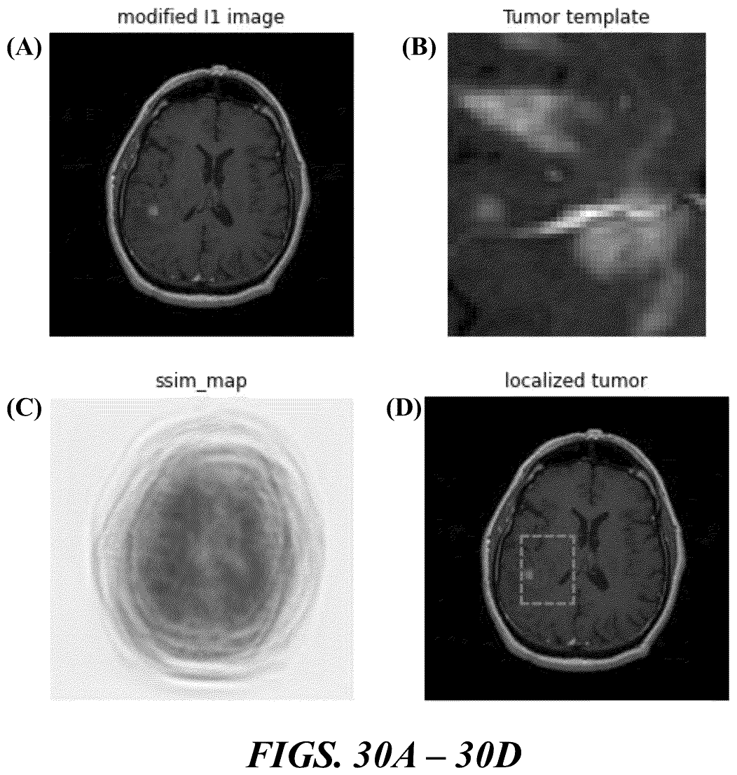

The result for using the same tumor template within the original image (11) itself are shown in FIG. 29. The system and method may also use a different tumor template, and the result is shown in FIG. 30. As such, the system and method are capable of detecting the tumor in both cases.

Based on the results, the smallest tumor size which the method can detect is of size 12×11 pixels. Which translates to detecting a tumor with diagonal of 15 mm according to the specifications of the dataset in use. (The dataset Pixel Spacing=Row Spacing \ Column Spacing=0.94\0.94 mm. This means the spacing between the centers of adjacent rows, or vertical spacing is 0.94 mm. Similarly, the spacing between the centers of adjacent columns, or horizontal spacing is 0.94 mm.).

Reference sub-images belongs to several categories normal, abnormal with the abnormality (having i different types, where i=1 to n). These sub-images can be detected and located with this method. The size of sub-images can be arbitrarily small to account for detecting smaller abnormalities. The system and method are applicable in transform domain. Since, transform methods have fast implementation, for a given computational complexity it allows us to have much higher resolution than staying in spatial domain.

The system and method are also approved for detecting the grade of the tumor within the same type. Also care should be taken to avoid correlating other similar portions such as bone parts corresponding to the boundaries of skull. As such, the smallest possible abnormality that can be detected is 15 mm in diameter.

The advantages set forth above, and those made apparent from the foregoing description, are efficiently attained. Since certain changes may be made in the above construction without departing from the scope of the invention, it is intended that all matters contained in the foregoing description or shown in the accompanying drawings shall be interpreted as illustrative and not in a limiting sense.

### INCORPORATION BY REFERENCE

Zhou Wang, A. C. Bovik, H. R. Sheikh and E. P. Simoncelli, “Image quality assessment: from error visibility to structural similarity,” in IEEE Transactions on Image Processing, vol. 13, no. 4, pp. 600-612, April 2004, doi: 10.1109/TIP.2003.819861.
Kenneth Clark, Bruce Vendt, Kirk Smith, John Freymann, Justin Kirby, Paul Koppel, Stephen Moore, Stanley Phillips, David Maffitt, Michael Pringle, et al., “The cancer imaging archive (tcia): maintaining and operating a public information repository,” Journal of digital imaging, vol. 26, no. 6, pp. 1045-1057, 2013.
Lisa Scarpace, Adam E Flanders, Rajan Jain, Tom Mikkelsen, and David W Andrews, “Data from rembrandt,” The Cancer Imaging Archive, vol. 10, pp. K9, 2015.
Rebecca L. Siegel, Kimberly D. Miller, Hannah E. Fuchs, and Ahmedin Jemal, “Cancer statistics, 2021,” CA: a cancer journal for clinicians, vol. 71, no. 1, pp. 7-33, 2021.
Neal R D, Johnson P, Clarke C A, Hamilton S A, Zhang N, Kumar H, Swanton C, Sasieni P. Cell-Free DNA-Based Multi-Cancer Early Detection Test in an Asymptomatic Screening Population (NHS-Galleri): Design of a Pragmatic, Prospective Randomised Controlled Trial. Cancers 2022 (Basel). October 1; 14 (19): 4818. doi: 10.3390/cancers14194818. PMID: 36230741; PMCID: PMC9564213.
“Cancer clinics begin to accommodate patients demanding new cancer detection tests”, Publish date: Jan. 9, 2023, by Kate Johnson, MDedge Hematology and Oncology.
Sajadi A S, Sabzpoushan S H. A New Seeded Region Growing Technique for Retinal Blood Vessels Extraction. Journal of medical signals and sensors. 2014 July; 4 (3): 223.
Pal, Nikhil R; Pal, Sankar K (1993). “A review on image segmentation techniques”. Pattern Recognition. 26 (9): 1277-1278. Bibcode: 1993PatRe. 26.1277P. doi: 10.1016/0031 3203 (93) 90135-J
Liu, J., Pan, Y., Li, M., Chen, Z., Tang, L., Lu, C., & Wang, J. (2018). Applications of deep learning to MRI images: A survey. Big Data Mining and Analytics, 1 (1), 1-18.
M. S. Fasihi and W. B. Mikhael, “Brain tumor grade classification Using LSTM Neural Networks with Domain Pre-Transforms,” 2021 IEEE International Midwest Symposium on Circuits and Systems (MWSCAS), Lansing, MI, USA, 2021, pp. 529-532, doi: 10.1109/MWSCAS47672.2021.9531760.
M. S. Fasihi and W. B. Mikhael, “MRI brain tumor classification Employing transform Domain projections,” 2020 IEEE 63rd International Midwest Symposium on Circuits and Systems (MWSCAS), Springfield, MA, USA, 2020, pp. 1020-1023, doi: 10.1109/MWSCAS48704.2020.9184678.
M. S. Fasihi and W. B. Mikhael, “Overview of Current Biomedical Image Segmentation Methods,” 2016 International Conference on Computational Science and Computational Intelligence (CSCI), Las Vegas, NV, USA, 2016, pp. 803-808, doi: 10.1109/CSCI.2016.0156.

All publications, patents, and patent applications mentioned in this specification are herein incorporated by reference to the same extent as if each individual publication, patent, or patent application was specifically and individually indicated to be incorporated by reference. To the extent publications and patents or patent applications incorporated by reference contradict the disclosure contained in the specification, the specification is intended to supersede and/or take precedence over any such contradictory material.

It is also to be understood that the following claims are intended to cover all of the generic and specific features of the invention herein described, and all statements of the scope of the invention which, as a matter of language, might be said to fall therebetween.

What is claimed is:

1. A computing device implemented method of automatically detecting at least one anomaly within a subject dataset, in real-time, the method comprising the steps of:
inputting, via at least one processor of a computing device, the subject dataset, a reference dataset, or both, wherein an appropriate marker, boundary, or both is defined based on the reference dataset;
preprocessing, via the at least one processor of the computing device, the subject data based on the defined marker, the defined boundary, or both; and
automatically identifying, via a similarity metric of the at least one processor, the at least one anomaly within the subject dataset by:
based on a determination that a calculated similarity is greater than or equal to a predetermined similarity threshold, transmitting a notification indicative of the at least one anomaly being present within the subject dataset; and
based on a determination that a calculated similarity is not greater than or equal to a predetermined similarity threshold, transmitting a notification indicative of the at least one anomaly not being present within the subject dataset.

2. The method of claim 1, wherein the at least one dataset comprises 1D signals, multidimensional signals, or both.

3. The method of claim 2, wherein the step of preprocessing the subject data based on the defined marker, the defined boundary, or both further comprises the step of, partitioning the subject dataset based on the defined marker, the defined boundary, or both based on the reference dataset.

4. The method of claim 3, wherein the subject dataset is partitioned into non-overlapping windows, overlapping windows, or both.

5. The method of claim 2, wherein the step of automatically identifying the at least one anomaly within the subject dataset further comprises the step of, calculating, via at least one correlation method of the at least one processor, a region of interest within the subject dataset based on the defined marker, the defined boundary, or both of the reference dataset.

6. The method of claim 5, wherein the step of automatically identifying the at least one anomaly within the subject dataset further comprises the steps of, highlighting the region of interest, via the at least one processor of the computing device, by:
based on a determination that the calculated similarity is greater than or equal to the predetermined similarity threshold, disposing, via a display device communicatively coupled to the at least one processor, a bounding box about the region of interest within the subject dataset; and
based on a determination that the calculated similarity is not greater than or equal to the predetermined similarity threshold, maintaining, in real-time, the subject dataset based on the defined marker, the defined boundary, or both of the reference dataset.

7. The method of claim 6, wherein the step of automatically identifying the at least one anomaly within the subject dataset further comprises the step of segmenting, via at least one segmentation algorithm of the at least one processor, the region of interest of the subject dataset, whereby the region of interest is partitioned, thereby optimizing a feature extraction of the at least one anomaly.

8. The method of claim 7, further comprising the step of extracting at least one feature, via at least one deep learning algorithm of the at least one processor, from the region of interest.

9. The method of claim 8, further comprising the step of determining, via at least one classifier of the at least one processor, the at least one extracted feature of the region of interest.

10. The method of claim 9, wherein the at least one extracted feature is selected from a group comprising of a tumor, healthy tissue, an aneurysm, a blood clot, gray matter, skull, brain matter, and a combination of thereof.

11. The method of claim 2, wherein the at least one processor implements Discrete Cosine Transform, Wavelet domains, or both on the subject dataset, the reference dataset, or both.

12. A system for automatically detecting at least one anomaly within a subject dataset, in real-time, the system comprising:
a computing device having at least one processor; and
a non-transitory computer-readable medium operably coupled to the processor, the computer-readable medium having computer-readable instructions stored thereon that, when executed by the at least one processor, cause the system to automatically detect at least one anomaly within a subject dataset by executing instructions comprising:
inputting, via at least one processor of a computing device, the subject dataset, a reference dataset, or both, wherein an appropriate marker, boundary, or both is defined based on the reference dataset;
preprocessing, via the at least one processor of the computing device, the subject data based on the defined marker, the defined boundary, or both; and
automatically identifying, via a similarity metric of the at least one processor, the at least one anomaly within the subject dataset by:
based on a determination that a calculated similarity is greater than or equal to a predetermined similarity threshold, transmitting a notification indicative of the at least one anomaly being present within the subject dataset; and
based on a determination that a calculated similarity is not greater than or equal to a predetermined similarity threshold, transmitting a notification indicative of the at least one anomaly not being present within the subject dataset.

13. The system of claim 12, wherein the at least one dataset comprises 1D signals, multidimensional signals, or both.

14. The system of claim 13, wherein the step of preprocessing the subject data based on the defined marker, the defined boundary, or both of the executed instructions further comprises the step of, partitioning the subject dataset based on the defined marker, the defined boundary, or both based on the reference dataset.

15. The system of claim 14, wherein the subject dataset is partitioned into non-overlapping windows, overlapping windows, or both.

16. The system of claim 13, wherein the step of automatically identifying the at least one anomaly within the subject dataset of the executed instructions further comprises the step of, calculating, via at least one correlation method of the at least one processor, a region of interest within the subject dataset based on the defined marker, the defined boundary, or both of the reference dataset.

17. The system of claim 16, wherein the step of automatically identifying the at least one anomaly within the subject dataset of the executed instructions further comprises the steps of, highlighting the region of interest, via the at least one processor of the computing device, by:
based on a determination that the calculated similarity is greater than or equal to the predetermined similarity threshold, disposing, via a display device communicatively coupled to the at least one processor, a bounding box about the region of interest within the subject dataset; and
based on a determination that the calculated similarity is not greater than or equal to the predetermined similarity threshold, maintaining, in real-time, the subject dataset based on the defined marker, the defined boundary, or both of the reference dataset.

18. The system of claim 17, wherein the step of automatically identifying the at least one anomaly within the subject dataset of the executed instructions further comprises the step of segmenting, via at least one segmentation algorithm of the at least one processor, the region of interest of the subject dataset, whereby the region of interest is partitioned, thereby optimizing a feature extraction of the at least one anomaly.

19. The system of claim 18, wherein the executed instructions further comprise the step of extracting at least one feature, via at least one deep learning algorithm of the at least one processor, from the region of interest.

20. The system of claim 19, wherein the executed instructions further comprise the step of determining, via at least one classifier of the at least one processor, the at least one extracted feature of the region of interest.
